(19) United States
(12) Patent Application Publication
(10) Pub. No.: US 2025/0321954 A1
(43) Pub. Date: Oct. 16, 2025

(54) QUERY OBJECT MAPPING METHOD, DEVICE AND PRODUCT

(71) Applicant: Xiangyang DoytoWin Software Technology Co., Ltd., Xiangyang City (CN)

(72) Inventor: Zhen YUAN, Xiangyang City (CN)

(21) Appl. No.: 18/780,416

(22) Filed: Jul. 22, 2024

(30) Foreign Application Priority Data
Apr. 11, 2024 (CN) 202410437379.6

(51) Int. Cl. G06F 16/242

(52) U.S. Cl. CPC G06F 16/242

(57) ABSTRACT

A query object mapping method, a device and a product are provided, and a technical field of database access is related to. The method includes: obtaining a query condition corresponding to each assigned field in an instance of a query object by applying an adapted field mapping method; and combining the query conditions into a query clause by using a logical AND operator; thereafter, constructing a complete database query statement based on the query clause, and then completing database access. Compared with the concept of the object-relational mapping (ORM) technology and an entity object in the prior art, the concept of the query object is newly defined, and a query object mapping method is provided. The method is used to map an instance of the query object into the query clause.

### CROSS-REFERENCE TO RELATED APPLICATION

This patent application claims the benefit and priority of Chinese Patent Application No. 202410437379.6 filed with the China National Intellectual Property Administration on Apr. 11, 2024, the disclosure of which is incorporated by reference herein in its entirety as part of the present application.

### TECHNICAL FIELD

The present disclosure relates to the technical field of database access, in particular to a query object mapping method, a device and a product.

### BACKGROUND

The existing object-relational mapping (ORM) technology needs to construct a database query statement according to query parameters submitted by users and the information of a database table to be accessed to complete the access to the database. One of the key steps is to construct query clauses in the database query statements from the query parameters. Each ORM framework provides different implementations, including but not limited to writing SQL statements by users themselves, such as MyBatis, SpringJdbc, etc., or using SQL-like technologies, such as HQL in Hibernate, JPQL in SpringDataJPA, LINQ in C#, etc., or using some constructions for conversion, such as a Criteria-related interface of Hibernate, a Specification interface of SpringDataJPA, etc., or using a chain construction method, such as jOOQ, etc. The phenomenon occurs because the object concept in the ORM technology only includes entity object and cannot cover the construction of query clauses. Therefore, various ORM frameworks have put forward some solutions. However, these schemes require users to write their own codes to construct query clauses, so that there is a large amount of coding, it is difficult to debug, and it takes a long time to develop. Therefore, how to construct query clauses efficiently becomes an urgent problem to be solved.

### SUMMARY

In view of this, the present disclosure provides a query object mapping method, a device and a product, and query clauses are obtained by a query object. Compared with the existing ORM technology, the present disclosure intensively defines the query conditions corresponding to each database table into the corresponding query object in the form of fields by newly defining the concept of the query object, and maps the instance of the query object created by users into the query clause by the query object mapping method provided by the present disclosure, so as to obtain a complete database query statement, thereby simplifying the construction process of the database query statement and improving the development efficiency.

In order to achieve the above objectives, the present disclosure provides the following scheme.

In a first aspect, the present disclosure provides a query object mapping method, including:
obtaining a query condition corresponding to each assigned field in an instance of a query object by applying an adapted field mapping method; where the field mapping method is used to map a field in the query object that meets a specific characteristic into a corresponding query
condition; and combining query conditions into a query clause by using a logical AND operator.

In a second aspect, the present disclosure provides a query object mapping method, including:
adapting and applying field mapping methods to all fields of a query object to obtain corresponding query conditions, and generating a query object mapping code; where the query object mapping code is correspondingly called by using an instance of the query object, and after execution, the query condition corresponding to each assigned field in the instance of the query object are obtained; and the query conditions are combined into a query clause using a logical AND operator.

In a third aspect, the present disclosure provides a data access device, including: an initialization module, configured to obtain the table name and column names of the target database table according to a definition of an entity object; and a database query statement mapping module, configured to map, based on the query object mapping method described above, an instance of a query object into a query clause, and splice the query clause with a table name and column names of the target database table to obtain a database query statement; a database query statement execution module, configured to submit the database query statement to a database for execution, and return a processed database execution result.

In a fourth aspect, the present disclosure provides a computer program product, including a computer program, where the computer program, when executed by a processor, implements the steps of the query object mapping method described in the first aspect.

According to the specific embodiments provided by the present disclosure, the present disclosure provides the following technical effects.

The present disclosure provides a query object mapping method, a device and a product, and relates to the technical field of database access. The method includes: obtaining a query condition corresponding to each assigned field in an instance of a query object by applying an adapted field mapping method; and combining the query conditions into a query clause by using a logical AND operator; thereafter, constructing a complete database query statement based on the query clause, and then completing database access. Compared with the concept of the object-relational mapping (ORM) technology and an entity object in the prior art, in the present disclosure, the concept of the query object is newly defined, and a query object mapping method is provided. The method is used to map an instance of the query object into the query clause, thus simplifying the coding related to the database access and improving the development efficiency.

### BRIEF DESCRIPTION OF THE DRAWINGS

In order to explain the embodiments of the present disclosure or the technical schemes in the prior art more clearly, the drawings that need to be used in the embodiments will be briefly introduced. Apparently, the drawings in the following description are only some embodiments of the present disclosure. For those ordinarily skilled in the art, other drawings can be obtained according to these drawings without creative labor.

FIG. 1 is a flowchart of mapping an instance of a query object into a query clause according to the present disclosure.

FIG. 2 is a technical conceptual diagram of mapping the instance of the query object into the query clause according to the present disclosure.

FIG. 3 is a flowchart of mapping the instance of the query object into the query clause according to Embodiment 1 of the present disclosure.

FIG. 4 is a flowchart of calling each module of a data access device according to Embodiment 3 of the present disclosure.

FIG. 5 is a schematic diagram of a combination of a development language and a database according to Embodiment 5 to Embodiment 8 of the present disclosure.

### DETAILED DESCRIPTION OF THE EMBODIMENTS

The technical schemes in the embodiments of the present disclosure will be clearly and completely described with reference to the drawings in the embodiments of the present disclosure hereinafter. Apparently, the described embodiments are only some embodiments of the present disclosure, rather than all of the embodiments. Based on the embodiments of the present disclosure, all other embodiments obtained by those skilled in the art without creative labor fall within the scope of protection of the present disclosure.

The present disclosure aims to provide a query object mapping method, a device and a product. Compared with the concept of the object-relational mapping (ORM) technology and an entity object widely used in the prior art, in the present disclosure, the concept of the query object is newly defined, and a query object mapping method is provided. The method is used to map an instance of the query object into the query clause. Based on the query object mapping method in the present disclosure, users only need to write the code defining the query object without writing the code constructing the query clause. The query clause corresponding to the instance of the query object is obtained by calling the query object mapping method encapsulated in the data access device through the constructed instance of the query object, and the query clause is spliced with the table name and the column name of the database table to access the database. The computer only needs to automatically generate the query clause according to the code of the query object written by the user in accordance with the steps of the query object mapping method in the present disclosure, thus simplifying the coding related to the database access and improving the development efficiency.

In order to make the above objectives, features and advantages of the present disclosure more obvious and understandable, the present disclosure will be explained in further detail with reference to the drawings and detailed description hereinafter.

### Embodiment 1

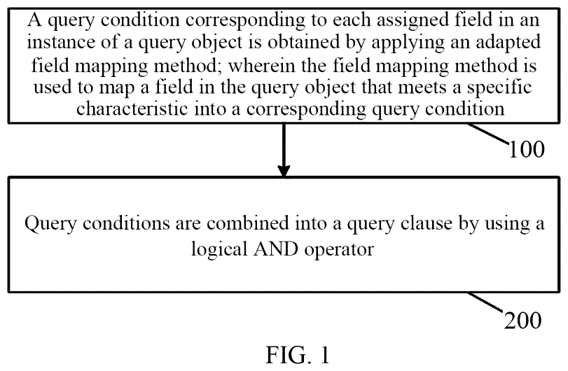

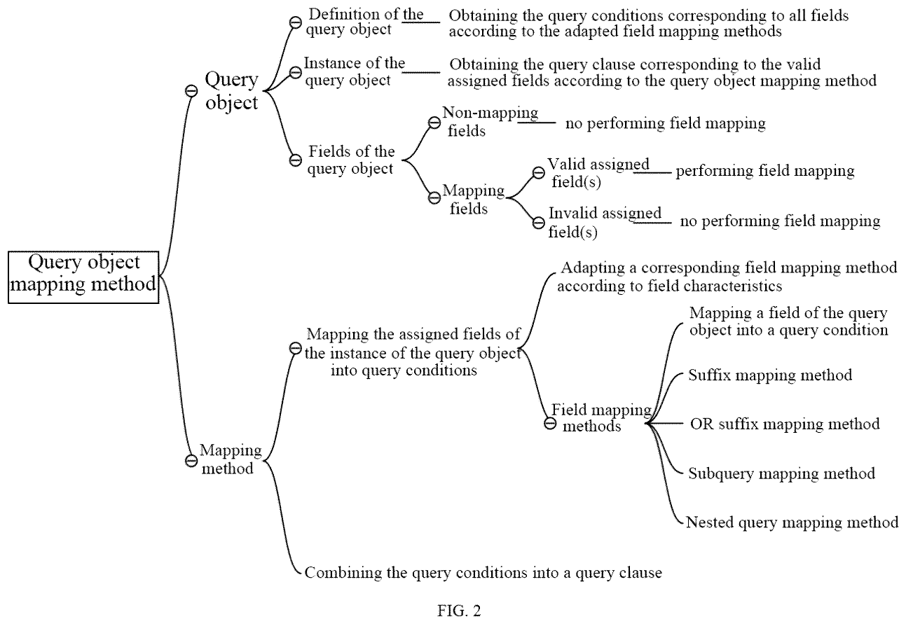

As shown in FIG. 1 and FIG. 2, the present disclosure provides a query object mapping method, which includes the following steps.

In Step 100, a query condition corresponding to each assigned field in an instance of a query object is obtained by applying an adapted field mapping method; where the field mapping method is used to map a field in the query object that meets a specific characteristic into a corresponding query condition.

The concept of the query object is a concept newly defined for mapping the query clause in the present disclosure, which intensively defines the query conditions corresponding to each database table into the corresponding query object in the form of fields. The query object is mainly used to map the query clause; the query object includes a definition of the query object and an instance of the query object; the definition of the query object is predefined by users according to the query clause to be mapped, which includes the name and the field of the query object; part or all of the fields of the query object are used to be mapped into a query condition; the fields used to be mapped into the query condition are referred to as mapping fields, and the fields not used to be mapped into the query condition are referred to as non-mapping fields; the name and the type of the mapping fields are predefined by applying the field mapping method in reverse according to the query condition to be mapped; and the instance of the query object is created and assigned by users according to the definition of the query object.

In Step 200, the query conditions are combined into a query clause by using a logical AND operator.

In the present disclosure, since all the query conditions need to be met at the same time when querying data, after obtaining the corresponding query conditions, the query conditions are combined into a query clause by using a logical AND operator. Different types of databases use different database query languages, the relational database uses the SQL, and the non-relational database uses user-defined query languages. Combining query clauses needs to conform to the specifications of the corresponding database query languages, and the expressions of the logical AND operator used for combination are also different. For example, the logical AND operator of the SQL is AND. Moreover, before combining into a query clause, brackets should be added to the query condition containing the OR operator. Therefore, in an alternative implementation of the embodiment of the present disclosure, various query conditions are combined into a query clause by using the logical AND operator. Specifically, the query conditions are combined into a query clause according to the format of the corresponding database query language by using the logical AND operator of the corresponding database query language.

The present disclosure can apply the reflection technology to acquire the assigned value of each field in the instance of the query object, and obtain the query condition corresponding to the assigned field. Therefore, an alternative implementation of Step 100 includes:
applying the reflection technology to acquire an assigned value of the field in the instance of the query object; adapting and applying the field mapping method to the assigned field to obtain the corresponding query conditions.

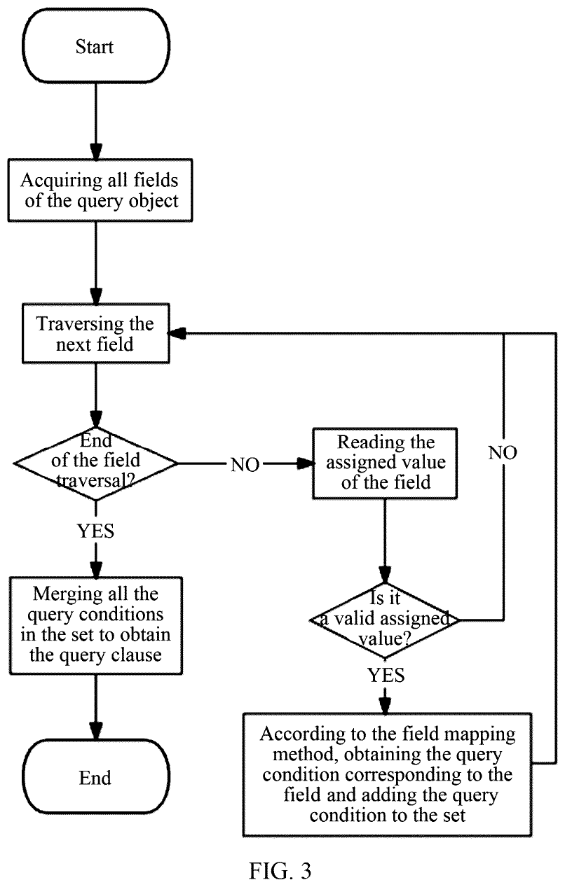

As shown in FIG. 3, this step specifically includes:
1) applying the reflection technology to acquire all fields of the query object;
2) traversing an i-th field of the query object, and judging whether all the fields are traversed to obtain a first traversal judgment result; i=1, 2, . . . ,N;
3) when the first traversal judgment result is NOT, applying the reflection technology to read the assigned value of the i-th field, and judging whether the i-th field has been assigned with a value to obtain a first assigned judgment result;
4) when the first assigned judgment result is NOT, i=i+1, and returning to execute the step of “traversing the i-th field of the query object”;
5) when the first assigned judgment result is YES, adapting and applying the field mapping method to the i-th field to obtain the query condition corresponding to the i-th field;
6) when the first traversal judgment result is YES, obtaining the query condition corresponding to each assigned field in the instance of the query object.

A more specific example process implemented based on a relational database and Java is as follows.

(1) It is assumed that the user has created a table in the relational database to store the data such as scores and memos of the users. The table is named user, and contains the following table columns: Column 1 which has the name of id and the type of int; Column 2 which has the name of score and the type of int; Column 3 which has the name of memo and the type of varchar (255). Now the user needs to query the data according to the size of the score and whether there are memos as a condition. Therefore, the user uses the Java language to define the following query object:

```
public class UserQuery{
  Integer scoreGt;
  Integer scoreLt;
  boolean memoNull;
}
```

in which scoreGt indicates to query data greater than a certain score, scoreLt indicates to query data less than a certain score, and memoNull indicates data with empty memo.

Users define each field of the query object by applying the field mapping method in reverse. Taking the suffix mapping method as an example, the suffix mapping method is used to map a field whose name contains a specific suffix in the query object into a corresponding query condition. The field name of the query object can be defined as a free combination of column names (id, score, memo here) and suffix names, such as id+Gt, score+Lt, etc. If users want to query data with a score less than a certain value, the users need to use the query condition “score <?”. When defining the field name, the column name of the score and the suffix Lt corresponding to the less-than sign are combined to obtain scoreLt as the name, and the corresponding numerical value can be assigned to the field scoreLt after the instance is created.
(2) The user creates an instance of UserQuery and assigns a value. It is assumed that the user wants to query the data with score less than 60 and no memo, then the user assigns the value of 60 to the field scoreLt and the value of true to the field memoNull.
(3) The reflection technology is applied to acquire the assigned value of the field of the instance of UserQuery, so that the value of the field scoreGt is null, the value of the field scoreLt is 60, and the value of the field memoNull is true.
(4) The field mapping method is adapted and applied to the assigned field to obtain the corresponding query condition: score <?, memo IS NULL, and the parameter list: [60].
(5) The AND operator is used to combine the obtained query conditions into a query clause: score <? AND memo IS NULL, and the parameter list: [60].

Because repeatedly adapting the field mapping method to the fields will affect the performance, the field mapping method can be adapted to all fields of the query object in advance, and the adaptation relationship is cached as a field mapping adaptation table to improve the adaptation speed of the field mapping method. The field mapping adaptation table records the corresponding relationship between each field of the query object and the adapted field mapping method. Therefore, another alternative embodiment of Step 100 is as follows.
(1) The field mapping methods are adapted to all fields of the query object to obtain a field mapping adaptation table corresponding to the query object.
(2) The reflection technology is applied to acquire the assigned value of each field in the instance of the query object.
(3) The field mapping method is adapted and applied to the assigned field according to the field mapping adaptation table to obtain the corresponding query conditions.

Taking the above example as a reference, the improved steps are as follows.
(1) The user defines the same query object UserQuery.
(2) The field mapping methods are adapted to all fields of UserQuery, so as to obtain the field mapping adaptation table corresponding to UserQuery: scoreGt corresponds to the suffix mapping method, scoreLt corresponds to the suffix mapping method, and memoNull corresponds to the suffix mapping method.
(3) The user creates an instance of UserQuery and assigns values. It is assumed that the user assigns the value of 60 to the field scoreLt and the value of true to the field memoNull.
(4) The reflection technology is applied to acquire the assigned value of the field of the instance of UserQuery, so that the value of the field scoreGt is null, the value of the field scoreLt is 60, and the value of the field memoNull is true.
(5) The suffix mapping method corresponding to the assigned field scoreLt is obtained according to the field mapping adaptation table described above. The suffix mapping method is applied to obtain the query condition score <?; the suffix mapping method corresponding to the assigned field memoNull is obtained, and the suffix mapping method is applied to obtain the query condition memo IS NULL. Finally, the query conditions corresponding to the above instances are obtained: score <? and memo IS NULL, and the parameter list: [60].
(6) The AND operator is used to combine the obtained query conditions into a query clause: score <? AND memo IS NULL, and the parameter list: [60].

The present disclosure includes various field mapping methods corresponding to different types of query conditions. For different development languages, the forms of defining fields are different. For different database query languages, the forms of the obtained query conditions are different. Therefore, each field mapping method needs to be implemented according to specific development languages and databases. A field mapping method suitable for different development languages and databases is referred to as a suffix mapping method, which is used to map a field whose name contains a specific suffix in the query object into a corresponding query condition and can also be described as mapping a field whose name contains a specific suffix in the query object into a corresponding query condition. Therefore, in an alternative implementation of the embodiment of the present disclosure, the suffix mapping method is applied to map the target field, which specifically includes the following steps.
(1) Suffix matching is carried out on a target field according to a suffix mapping table, so as to determine the suffix of the target field; the suffix mapping table includes suffix names and operators corresponding to different databases; the target field refers to the field adapted to the suffix mapping method. The process of carrying out suffix matching can be completed by regular expressions. Part of the suffix mapping table is shown in Table 1.

| Suffix name | SQL operator | MongoDB operator |
|---|---|---|
| (EMPTY) | = | $eq |
| Eq | = | $eq |
| Not | != | $ne |
| Ne | <> | $ne |
| Gt | > | $gt |
| Ge | >= | $gte |
| Lt | < | $lt |
| Le | <= | $lte |
| NotIn | NOT IN | $nin |
| In | IN | $in |
| Null | IS [NOT] NULL | [$not+]$type |
| NotLike | NOT LIKE | $not + $regex |
| Like | LIKE | $regex |
| NotStart | NOT LIKE | $not + $regex |
| Start | LIKE | $regex |
| NotEnd | NOT LIKE | $not + $regex |
| End | LIKE | $regex |
| NotContain | NOT LIKE | $not + $regex |
| Contain | LIKE | $regex |

(2) The field suffix is removed from the target field to obtain the target column name.
(3) The operator corresponding to the suffix of the target field is obtained according to the suffix mapping table.
(4) According to the assigned value corresponding to the target field, the operator and the target column name, and the format of the corresponding database query condition, the query condition corresponding to the target field is obtained. If the user configures a column name deformation strategy, the target column name needs to be further processed. For example, the column name of the field is createTimeGt, createTime is obtained after removing the suffix Gt, and then the createTimeGt is deformed according to the configuration of users, so as to obtain the final column name.

Table 2 shows the implementation comparison of the suffix mapping method in the relational database and MongoDB. For the convenience of comparison, when making this table, the SQL query conditions in the example contain specific parameter values. However, in the implementation process, in order to prevent SQL injection, it is recommended to replace the parameter values in the query conditions with placeholders using the practices accepted in the industry.

| | | assigned | | |
|---|---|---|---|---|
| | | value | | |
| | | of the | SQL query | MongoDB query |
| Suffix name | field name | field | conditions | conditions |
| (EMPTY) | id | 5 | id = 5 | {“id”: 5} |
| Eq | idEq | 5 | id = 5 | {“idEq”: 5} |
| Not | idNot | 5 | id != 5 | {“idNot”: {“$ne”: 5}} |
| Ne | idNe | 5 | id <> 5 | {“idNe”: {“$ne”: 5}} |
| Gt | idGt | 5 | id > 5 | {“idGt”: {“$gt”: 5}} |
| Ge | idGe | 5 | id >= 5 | {“idGe”: {“$gte”: 5}} |
| Lt | idLt | 5 | id < 5 | {“idLt”: {“$lt”: 5}} |
| Le | idLe | 5 | id <= 5 | {“idLe”: {“$lte”: 5}} |
| NotIn | idNotIn | [1, 2, 3] | id NOT IN (1, 2, 3) | {“id”: {“$nin”: [1, 2, 3]}} |
| In | idIn | [1, 2, 3] | id IN (1, 2, 3) | {“id”: {“$in”: [1, 2, 3]}} |
| Null | memoNull | false | memo IS NOT | {“memo”: {“$not”: |
| | | | NULL | {“$type”, 10}}} |
| Null | memoNull | true | memo IS NULL | {“memo”: {“$type”, 10}} |
| NotLike | nameNotLike | “arg” | name NOT LIKE | {“name”: {“$not”: |
| | | | ‘% arg %’ | {“$regex”: “arg”}}} |
| Like | nameLike | “arg” | name LIKE | {“name”: {$regex: “arg”} |
| | | | ‘% arg %’ | |
| NotStart | nameNotStart | “arg” | name NOT LIKE | {“name”: {“$not”: |
| | | | ‘arg %’ | {“$regex”: “\hat{ }arg”}}} |
| Start | nameStart | “arg” | name LIKE ‘arg %’ | {“name”: {$regex: “\hat{ }arg”} |
| NotEnd | nameNotEnd | “arg” | name NOT LIKE | {“name”: {“$not”: |
| | | | ‘% arg’ | {“$regex”: “arg$”}}} |
| End | nameEnd | “arg” | name LIKE ‘% arg’ | {“name”: {$regex: “arg$”} |
| NotContain | nameNotContain | “arg” | name NOT LIKE | {“name”: {“$not”: |
| | | | ‘% arg %’ | {“$regex”: “arg”}}} |
| Contain | nameContain | “arg” | name LIKE | {“name”: {$regex: “arg”} |
| | | | ‘% arg %’ | |

Besides the suffix mapping method, the present disclosure further provides various field mapping methods. The specific implementation of the field mapping method is affected by the database and the programming language, which cannot be listed one by one. The relational database and the Java programming language are only used to explain some main field mapping methods.

As an example, in the embodiment of the present disclosure, the field mapping method further includes an annotation mapping method, which is suitable for the field to which the query mapping annotation is added. Taking the account field as an example, the steps of implementing the annotation mapping method are as follows:

@QueryField(and = “(username = ? OR email = ? OR mobile = ?)”)
private String account.

1) The string annotated by @QueryField of the field is read as the query condition (username=? OR email=? OR mobile=?).
2) Corresponding parameter values are added according to the number of placeholders in the query conditions.

As an example, in the embodiment of the present disclosure, the field mapping method further includes an Or suffix mapping method, which is suitable for fields with the name suffix of OR or _or. When a plurality of query conditions are obtained, a logical OR operator is used for combination. In the implementation process, the corresponding steps are executed according to the type of fields.

When the type of fields is a query object, the query object also contains a plurality of fields that can be mapped into query conditions. For an instance of such type of objects, Step 100 is recursively executed to map each assigned field into a query condition, and the logical OR operator is used for combination. The corresponding steps are as follows.
1) Step 100 is executed for the instance of the assigned value of the field to obtain the query conditions corresponding to the assigned field.
2) The logical OR operator is used to combine all query conditions.

The specific example is as follows.

The field accountOr is defined in the query object UserQuery, and the type is another object Account.

```
public class Account {
  private String username;
  private String email;
  private String mobile;
}
public class UserQuery {
  private Account accountOr;
}
```

Description of examples: 1) when all three fields in the Account instance where the accountOr field is assigned a value are assigned values, according to Step 100, the query conditions corresponding to these three fields are obtained: username=?, email=?,mobile=?; 2) the OR operator is used to combine all the query conditions to obtain the query conditions corresponding to the accountOr field: username=? OR email=? OR mobile=?.

When the type of fields is a set and the instance of the set is a query object, the corresponding steps are as follows.
1) According to the query object mapping method, each instance in the set is mapped to obtain a set of corresponding subquery clauses; the subquery clauses are used to be combined into a query condition.

Each instance will be used as an instance of the query object. The query object mapping method is recursively applied to obtain a corresponding subquery clause. There are a plurality of instances in a set. Each instance corresponds to a subquery clause, so as to obtain a plurality of sets of subquery clauses.
2) The logical OR operator is used to combine all subquery clauses.

For example, for the accountsOr field defined as follows:

public class UserQuery {
private List<Account > accountsOr;
}

It is assumed that the list in which a value is assigned to the accountsOr field contains three instances of Account. The username and mobile fields of the first instance are assigned values, the email and mobile fields of the second instance are assigned values, and all the fields of the third instance are assigned values. The specific mapping steps are as follows.
1) The first instance is mapped into: (username=? AND mobile=?); the second instance is mapped into: (email=? AND mobile=?); the third instance is mapped into: (username=? AND email=? AND mobile=?).
2) These subquery clauses are spliced using the OR operator to obtain the query conditions corresponding to the field accountsOr: (username=? AND mobile=?) OR (email=? AND mobile=?) OR (username=? AND email=? AND mobile=?).

When the type of fields is set and the instance of the set is a basic object (such as a string, an integer type, a floating-point type, Boolean, etc.), the corresponding steps are as follows.
1) The suffix Or or_or of the field name is removed, and the suffix mapping method is applied to obtain the corresponding template query conditions.
2) The corresponding number of template query conditions are obtained according to the number of elements of the assigned set, and all template query conditions are combined by using the OR operator to obtain the query conditions corresponding to the fields.

For example, the usernameOr field is defined as follows:

public class UserQuery {
private List<String > usernameContainOr;
}

1) usernameContainOr removes the suffix Or to obtain usernameContain, and applies the suffix mapping method to usernameContain to obtain the query condition: username LIKE?;
2) Assuming that the assigned set has three elements, three identical query conditions are obtained correspondingly; the OR operator is used to combine all the query conditions to obtain the query condition corresponding to the usernameContainOr field: username LIKE? OR username LIKE? OR username LIKE?.

When the type of fields is a basic object, the corresponding steps are as follows.

The suffix Or or_or of the field name is removed, and the suffix mapping method is applied to obtain the corresponding query condition.

When the type of fields is another type, the fields can be supported according to the implementation.

As an example, in the embodiment of the present disclosure, the field mapping method includes a subquery mapping method, which is suitable for fields to which subquery annotations are added. The field naming format can be the column name+the operator suffix (such as Eq, Lt, Ge, etc.)+Any/All. Taking the scoreLtAll field as an example, the steps of the subquery mapping method are as follows:

@Subquery(select = “score”, from = UserEntity.class)
UserQuery scoreLtAll;

1) score <ALL is obtained from scoreLtAll splitting.
2) The subquery statement SELECT score FROM t_user is obtained from the annotation @Subquery.
3) The query clause corresponding to the instance of the assigned value of the field scoreLtAll is obtained as the WHERE clause of the above subquery statement according to the query object mapping method, and brackets are added to obtain: (SELECT score FROM t_user WHERE . . . ).
4) The statement fragments obtained in Step 1) and Step 3) are spliced to obtain the query condition score <all (SELECT score FROM t_user WHERE . . . ).

As an example, in the embodiment of the present disclosure, the field mapping method further includes a nested query mapping method, which is suitable for the fields to which nested query annotations are added. The nested query mapping method has the following process.

Suppose we have a USER table t_user and a ROLE tablet_role. The USER table and the ROLE table are in a many-to-many relationship, which are stored in the intermediate table a_user_and_role. The field user_id in a_user_and_role is a foreign key pointing to the id field of the t_user table, and the field role_id in a_user_and_role is a foreign key pointing to the id field of the t_role table.

Now we want to query user records that are assigned a role named “admin”. Therefore, we define a query object RoleQuery for the ROLE table which contains a field of type String and name roleName. Thereafter, a field in which the name is role, the type is RoleQuery and it is annotated with @Domainpath ({“user”, “role”}) is added to the UserQuery class:

```
public class UserQuery {
  @DomainPath({“user”, “role”})
  RoleQuery role;
}
```

We can draw the following information from the annotation @Domainpath ({“user”, “role”}): the names of the two domain tables, t_user and t_role; the name of the intermediate table, a_user_and_role; the names of the two foreign key columns, user_id and role_id. Based on this information, a query condition template corresponding to the field role can be generated: id IN (SELECT user_id FROM a_user_and_role WHERE role_id IN (SELECT id FROM t_role [WHERE])).

When performing a query, an instance of RoleQuery is first created, and the value “admin” is assigned to the field roleName. An instance of UserQuery is then created, and the instance of RoleQuery is assigned to the field role of the UserQuery instance. The specific mapping steps for the UserQuery instance are as follows:
1) according to the query object mapping method, the query clause is mapped by the instance of the field role: role_name= ‘admin’;
2) the above query clause is substituted into the WHERE clause of the above query condition template to obtain the query condition corresponding to the field role: id IN (SELECT user id FROM a_user_and_role WHERE role_id IN (SELECT id FROM t_role WHERE role_name= ‘admin’)).

Because a plurality of subquery statements are nested in the query conditions, the method is named the nested query mapping method.

In the present disclosure, there are many field mapping methods. Before applying the field mapping method to the field, it is necessary to adapt the corresponding field mapping method to the field according to the features of the field of the query object. The specific steps are as follows.
(i) The field of the query object is acquired, and whether the current field mapping method is adapted to the field is judged sequentially according to the preset order of the field mapping method, an adaptation judgment result is obtained,
(ii) When the adaptation judgment result is YES, the current field mapping method is taken as the adaptation result.
(iii) When the adaptation judgment result is NO, the adaptation judgment of the next field mapping method is executed; when there is no next field mapping method, the suffix mapping method is taken as the adaptation result.

In the present disclosure, when Step 100 is executed and no query condition is obtained, Step 200 is executed and no query clause is obtained. When the field mapping method is applied to the field and the query object mapping method is recursively executed, it is also possible that no query clause is obtained, in which case the query condition obtained is null.

In the present disclosure, a query clause is obtained according to the scheme of the embodiment, and a complete database query statement is further obtained, thereby completing database access. In an alternative implementation of the embodiment of the present disclosure, the query clause is spliced with the corresponding table names, column names, sorting clauses and pagination clauses to obtain the database query statement of the database to be accessed; the table names and the column names are table names and column names in the database table of the database to be accessed; the table names and the column names are obtained by mapping an entity object; the sorting clauses and the pagination clauses are obtained by mapping according to the pagination object inherited by the query object; the pagination object contains three non-mapping fields: an integer-type page number field pageNumber, an integer-type page size field pageSize, and a string-type sorting field sort. The fields pageNumber and pageSize are used to construct pagination clauses. The field sort is used to construct sorting clauses. The specific construction methods of pagination clauses and sorting clauses can refer to the existing technology.

In the embodiment of the present disclosure, because the product implemented according to the present disclosure is used, the user only needs to define an entity object and a query object for each data table, and define a corresponding data access interface according to the accessed database for implementation, so that the object can be easily mapped into a query statement conforming to the corresponding database query language format, and then the database access can be completed.

In the ORM technology, in order to map objects to the database query statement, the ORM framework usually provides an intermediate carrier, which requires users to create an instance of the intermediate carrier according to query parameters by coding. Thereafter, the ORM framework maps the instance of the intermediate carrier into the database query statement. This part of coding is usually complicated and has a large number of codes. On the basis of the prior art, the present disclosure can directly map objects into database query statements through the definition of concepts such as query objects and the formulation of field mapping methods, eliminating the step of constructing the intermediate carrier, and reducing the number of codes and the debugging difficulty, so that the development time is shorter and the development efficiency is higher. In the present disclosure, because an intermediate step is removed, from the perspective of developers, all codes corresponding to this step can be omitted, and only certain predetermined rules need to be followed when defining objects. From the perspective of implementing the scheme, the present disclosure simplifies an intermediate step, so that the scope of application of the present disclosure is wider.

### Embodiment 2

As shown in FIG. 1 and FIG. 2, the embodiment is different from Embodiment 1 in that the embodiment uses the method of generating the query object mapping code, a generated query object mapping code is called and executed to obtain the query condition corresponding to each assigned field in the instance of the query object.

In the scheme of the embodiment, the query object mapping code can be pre-generated, so that the query condition corresponding to the instance of the query object can be obtained by directly calling subsequently. Therefore, the present disclosure provides a query object mapping method, including:
adapting and applying the field mapping methods to all fields of a query object to obtain corresponding query conditions, and generating a query object mapping code.

Specifically, the step of generating the query object mapping code is as follows.
(1) All fields of the query object are acquired through the abstract syntax tree technology.
(2) The field mapping method is adapted and applied to all fields of the query object to obtain the corresponding query condition; a set of corresponding mapping instructions is generated for each field of the query object; where the mapping instruction at least includes an assigned judgment instruction and a query condition collection instruction; the assigned judgment instruction is used to judge whether the corresponding field has been assigned a value; the query condition collection instruction is used to collect the query condition corresponding to the assigned field.

As an example, this step specifically includes:
1) traversing the j-th field of the query object, and judging whether all the fields are traversed to obtain a second traversal judgment result; j=1, 2, . . . ,M;
2) when the second traversal judgment result is NO, adapting and applying the field mapping method according to the features of the j-th field to obtain the query conditions corresponding to the j-th field, and generating a set of mapping instructions for the j-th field;
3) assuming that j=j+1 and returning to Step “traversing the j-th field of the query object”; and
4) when the second traversal judgment result is YES, obtaining M sets of mapping instructions corresponding to M fields of the query object.
(3) A query object mapping code is generated according to the M sets of mapping instructions and other instructions required by calling the method, and the query object mapping code is output as a source code file to be compiled and executed. The generated query object mapping code includes the query conditions corresponding to all fields of the query object.

Another alternative implementation of Step 100, being obtained by directly calling the pre-generated query object mapping code to obtain the query condition corresponding to each assigned field in the instance of the query object, which specifically includes:
calling and executing a query object mapping code by using the instance of the query object to obtain the query condition corresponding to each assigned field in the instance of the query object.

Specifically, the execution steps of the query object mapping code are as follows.
(1) A user creates an instance of the query object, calls the aforementioned query object mapping code, executes the assigned judgment instructions in the aforementioned M sets of mapping instructions sequentially, and judges whether the corresponding field has been assigned a value, so as to obtain a second assigned judgment result.
(2) When the second assigned judgment result is YES, the corresponding query condition collection instruction is called to collect the corresponding query condition.
(3) When the second assigned judgment result is NO, the next assigned judgment instruction is called. When all the pre-generated instructions are executed, the query conditions corresponding to each assigned field in the instance of the query object are obtained.

In the embodiment, the implementers of the generating step and the executing step of the query object mapping code are generally not the same: the implementer of the generating step is usually an independent software vendor; the implementer of the executing step is usually a company that develops a database-based application system, such as various Internet companies and financial companies.

An example of generating the query object mapping code based on Go language and MongoDB database is as follows.
1. It is assumed that the user uses Go language to define the following query object:

```
type UserQuery struct {
  ScoreGt *int
  ScoreLt *int
  memoNull *bool
}
```

2. All the fields of the query object UserQuery are acquired to obtain ScoreGt, ScoreLt, MemeNull. The field mapping method is adapted for these fields to obtain the mapping relationship between the fields of the query object UserQuery and the query conditions as follows: {ScoreGt: D {{“score”, D {{“$gt”, q. ScoreGt}}}, ScoreLt: D {{“score”, D {{“$It”, q. ScoreLt}}}}, memoNull: D {{“memo”, D {{“$type”, 10}}}}}. A set of mapping instructions is generated for each set of mapping relationships. Each set of mapping instructions at least includes an assigned judgment instruction and a query condition collection instruction, and the query condition collection instruction is executed only when the judgment is true. Taking the field ScoreGt as an example, the assigned judgment instruction generated for the field is: q. ScoreGt!=nil, and the query condition collection instruction generated for the field is: d=append (d, D {{“score”, D {{“$gt”, q. ScoreGt}}}}). Each set of mapping instructions is used to determine a corresponding query condition.
3. The complete package name and reference instruction, the method definition instruction, the return value definition instruction, the return value return instruction, etc. are generated for the whole class to generate a complete query object mapping code as follows:

```
package main
import. “go.mongodb.org/mongo-driver/bson/primitive”
func (q UserQuery) BuildFilter( ) A {
  d := make(A, 0, 4)
  if q.ScoreGt != nil {
    d = append(d, D{{“score”, D{{“$gt”, q.ScoreGt}}}})
  }
  if q.ScoreLt != nil {
    d = append(d, D{{“score”, D{{“$lt”, q.ScoreLt}}}})
  }
  if q.memoNull != nil {
    d = append(d, D{{“memo”, D{{“$type”, 10}}}})
  }
  return d
}
```

It is assumed that the user creates an instance of UserQuery and assigns a value of 60 to the field scoreLt and a value of true to the field memoNull; the user calls the above code using this instance, and the query conditions obtained after execution are: {“score”: {“$lt”: 60}}, {“memo”: {“$type”, 10}}.

In addition, for the query conditions in the SQL statements, since placeholders will be used to replace the parameters in the query conditions, that is, the field scoreLt may be mapped into score <?, the corresponding set of mapping instructions may further include a query parameter collection instruction, such as:

assigned judgment instruction: if q.ScoreLt != nil {...}
query condition collection instruction: conditions = append(conditions,
“score < ?”)
query parameter collection instruction: args = append(args, q.ScoreLt)

The code examples here are mainly used to illustrate the specific forms of the assigned judgment instruction and the query condition collection instruction of the field, and show a query object mapping code that is capable of being compiled and executed.

### Embodiment 3

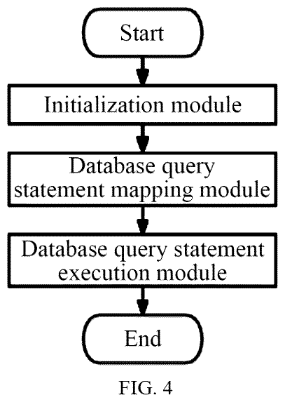

As shown in FIG. 4, the present disclosure provides a data access device, which includes: an initialization module, a database query statement mapping module, and a database query statement execution module. The initialization module is configured to obtain the table name and column names of the target database table according to the definition of the entity object. The database query statement mapping module is configured to map, based on the query object mapping method described in Embodiment 1 or Embodiment 2, an instance of a query object into a query clause, and splice the query clause with a table name and column names of the target database table to obtain a corresponding database query statement. The database query statement execution module is configured to submit the database query statement to a database for execution, and return a processed execution result.

The call flow of each module of the data access device is as follows.

In Step 1, a database and a database table are created, and a corresponding entity object and a query object are written for each database table.

In Step 2, a data access device is created, and the definition of the entity object is used to call the initialization module to obtain the table name and the column name of the database table corresponding to the entity object.

In Step 3, an instance of the query object is created and assigned with a value, and the instance is used as a parameter to call the database query statement mapping module of the data access device to obtain the database query statement.

In Step 3.1, the instance of the query object is mapped into a query clause according to the query object mapping method.

In Step 3.2, the sorting clause is obtained according to the page number and page size fields (if being assigned) of the pagination object inherited by the query object.

In Step 3.3, the pagination clause is obtained according to the sorting field (if being assigned) of the pagination object inherited by the query object.

In Step 3.4, the above clauses and the table names and the column name of the database table obtained in Step 2 are spliced according to the database query statement template to obtain the corresponding database query statement.

In Step 4, the database query statement is used as a parameter, and the database query statement execution module of the data access device is called to obtain an execution result.

### Embodiment 4

The present disclosure provides a computer program product, which includes a computer program, where the computer program, when executed by a processor, implements the steps of the query object mapping method described in Embodiment 1 or Embodiment 2.

### Embodiment 5

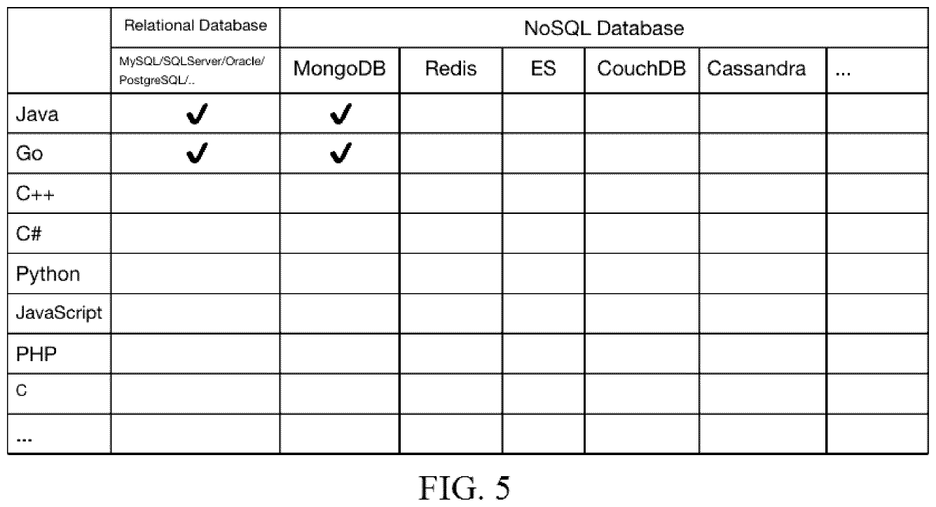

As shown in FIG. 5, there are several (N) types of programming languages and several (M) types of database query languages. The programming languages and the database query languages are embodied, and the query object mapping method provided in Embodiment 1 and Embodiment 2 can be applied to the cases of N*M combinations of programming languages and databases.

The embodiment of the present disclosure is the embodiment based on a relational database and Java language, where the programming language used when defining the query object is Java, and the database to be accessed is a relational database. The specific mapping flow of applying the method provided in Embodiment 1 is as follows.
(1) For the USER table and the query requirements described in Embodiment 1, the user uses Java language to define the following query object:

```
public class UserQuery{
  Integer scoreGt;
  Integer scoreLt;
  boolean memoNull;
}
```

(2) The user creates the instance of the query object and assigns a value. It is assumed that the user assigns a value of 60 to the field scoreLt and a value of true to the field memoNull.
(3) The field mapping method is adapted and applied to the assigned fields scoreLt and memoNull to obtain the corresponding query condition: score <?, memo IS NULL, and the parameter list: [60].
(4) The AND operator is used to combine the obtained query conditions into a query clause: score <? AND memo IS NULL, and the parameter list: [60].

### Embodiment 6

The embodiment of the present disclosure is the embodiment based on the non-relational database MongoDB and Java language, where the programming language used when defining the query object is Java, and the database to be accessed is a non-relational database MongoDB. The specific mapping flow of applying the method provided in Embodiment 1 or Embodiment 2 is as follows.

(1) It is assumed that the user has created a Collection in the MongoDB database to store the data such as scores and memos of the users. The Collection is named user, and contains the following fields: Field 1 which has the name of id and the type of Integer; Field 2 which has the name of score and the type of Integer; Field 3 which has the name of memo and the type of String. Now the user needs to query the data according to the size of the score and whether there are comments as a condition. Therefore, the user uses the Java language to define the following query object:

```
public class UserQuery{
  Integer scoreGt;
  Integer scoreLt;
  boolean memoNull;
}
```

(2) The user creates an instance of the query object and assigns the values. It is assumed that the value of 60 is assigned to the field scoreLt and the value of true is assigned to the field memoNull.
(3) The field mapping method is adapted and applied to the assigned fields ScoreLt and MemoNull to obtain the corresponding query condition: {“score”: {“$lt”: 60}}, {“memo”: {“$type”, 10}}.
(4) The “$and” operator is used to combine the obtained query conditions into query clauses, and the corresponding text form of the query clauses in MongoDB is: {“$and”: [{“score”: {“$lt”: 60}}, {“memo”: {“$type”, 10}}]}.

According to the query clause and the document set and the field name to be accessed, the query statement in MongoDB can be further obtained. The text form of the query statement executed in the console is:

db.user.find({“$and”: [{“score”: {“$lt”: 60}},
{“memo”: {“$type”, 10}}]})
.projection(“id”, “score”, “memo”)

Because the data query logic is the same, and both codes are written in Java, the same point as Embodiment 5 is that the defined query objects are the same; because the types of the accessed databases are different, the difference from Embodiment 5 is that the formats of the output query statements are different.

### Embodiment 7

The embodiment of the present disclosure is the embodiment based on a relational database and Go language, where the programming language used when defining the query object is Go, and the database to be accessed is a relational database. The specific mapping flow of applying the method provided in Embodiment 1 or Embodiment 2 is as follows.
(1) For the USER table and the query requirements described in Embodiment 1, the user uses Go language to define the following query object:

```
type UserQuery struct {
  ScoreGt *int
  ScoreLt *int
  MemoNull *bool
}
```

(2) The user creates the instance of the query object and assigns a value. It is assumed that the user assigns a value of 60 to the field ScoreLt and a value of true to the field MemoNull.
(3) The field mapping method is adapted and applied to the assigned fields ScoreLt and MemoNull to obtain the corresponding query condition: score <?, memo IS NULL, and the parameter list: [60].
(4) The AND operator is used to combine the obtained query conditions into a query clause: score <? AND memo IS NULL, and the parameter list: [60].

Because Embodiment 7 and Embodiment 5 are both based on the relational databases and have the same query logic, the same point as Embodiment 5 is that the output query statements are the same; because the used development languages are different, the difference from Embodiment 5 is that the syntax for defining the query object is different.

Embodiment 5 to Embodiment 7 use two programming languages and two databases with different database query languages for combination. Those skilled in the art can use the present disclosure for the implementation of the combination of Go language and MongoDB, as well as the implementation of the combination of N*M programming languages and databases mentioned in Embodiment 6 without paying creative labor.

### Embodiment 8

It should be noted that in order to make a better comparison with the ORM technology and facilitate the understanding of those skilled in the art, the present disclosure mainly explains the technical features and steps of the present disclosure using the related terms of object-oriented programming, but it does not mean that the present disclosure can only be used in object-oriented programming languages. Taking C, a representative procedure-oriented programming language, as an example, the following structures are defined:

```
struct UserQuery
{
  *int scoreGt;
  *int scoreGt;
  *bool memoNull;
};
```

It can be seen that there are only grammatical differences between the query objects defined in Embodiment 8 and Embodiment 5 to Embodiment 7, and the relevant steps of the present disclosure are still applicable to the structure. Therefore, the structure used to be mapped into a query clause in the procedure-oriented programming language should be regarded as the same concept as the query object. The structure variable should be regarded as the same concept as the instance of the query object. The field mapping method is also applicable to the member variables in the structure. Therefore, those skilled in the art can apply the present disclosure to other procedure-oriented programming languages without creative labor.

### Embodiment 9

On the basis of the scheme in Embodiment 1 or Embodiment 2, the embodiment further explains the field traversal process of the query object: if the user is allowed to add an non-mapping field in the query object during implementation, it is necessary to add a judgment whether the field belongs to an non-mapping field after traversing the judgment result when traversing the field of the query object; if the judgment result is YES, the field is skipped, and the next field is traversed. That is, when traversing the field of the query object, the non-mapping fields of the query object are skipped.

Taking Java implementation as an example, static fields, fields annotated by @Transient and fields annotated by @Join are regarded as non-mapping fields.

The differences between each embodiment and other embodiments are highlighted, and the same and similar parts of various embodiments can be referred to each other.

In the present disclosure, specific examples are applied to illustrate the principle and implementation of the present disclosure, and the explanations of the above embodiments are only used to help understand the method and core ideas of the present disclosure. At the same time, according to the idea of the present disclosure, there will be some changes in the specific implementation and application scope for those skilled in the art. To sum up, the contents of the specification should not be construed as limiting the present disclosure.

What is claimed is:

1. A query object mapping method, comprising:
obtaining a query condition corresponding to each assigned field in an instance of a query object by applying an adapted field mapping method; wherein the field mapping method is used to map a field in the query object that meets a specific characteristic into a corresponding query condition; and
combining query conditions into a query clause by using a logical AND operator.

2. The query object mapping method according to claim 1, wherein the obtaining a query condition corresponding to each assigned field in an instance of a query object by applying an adapted field mapping method comprises:
acquiring an assigned value of each field in the instance of the query object by applying a reflection technology; and
adapting and applying the field mapping method to the assigned field to obtain the corresponding query condition.

3. The query object mapping method according to claim 1, wherein the obtaining a query condition corresponding to each assigned field in an instance of a query object by applying an adapted field mapping method comprises:
adapting the field mapping methods to all fields of the query object to obtain a field mapping adaptation table corresponding to the query object;
acquiring an assigned value of each field in the instance of the query object by applying a reflection technology; and
adapting and applying the field mapping method to the assigned field according to the field mapping adaptation table to obtain the corresponding query condition.

4. The query object mapping method according to claim 1, wherein the obtaining a query condition corresponding to each assigned field in an instance of a query object by applying an adapted field mapping method comprises:
calling and executing a query object mapping code by using the instance of the query object to obtain the query condition corresponding to each assigned field in the instance of the query object; wherein the query object mapping code is generated according to all fields of the query object and the corresponding query conditions obtained by adapting and applying the field mapping methods.

5. The query object mapping method according to claim 1, wherein the field mapping method comprises:
a suffix mapping method, configured to map a field whose name contains a specific suffix in the query object into a corresponding query condition.

6. The query object mapping method according to claim 2, wherein the field mapping method comprises:
a suffix mapping method, configured to map a field whose name contains a specific suffix in the query object into a corresponding query condition.

7. The query object mapping method according to claim 3, wherein the field mapping method comprises:
a suffix mapping method, configured to map a field whose name contains a specific suffix in the query object into a corresponding query condition.

8. The query object mapping method according to claim 4, wherein the field mapping method comprises:
a suffix mapping method, configured to map a field whose name contains a specific suffix in the query object into a corresponding query condition.

9. A query object mapping method, comprising:
adapting and applying field mapping methods to all fields of a query object to obtain corresponding query conditions, and generating a query object mapping code; wherein the query object mapping code is correspondingly called by using an instance of the query object, and after execution, the query condition corresponding to each assigned field in the instance of the query object are obtained; and the query conditions are combined into a query clause using a logical AND operator.

10. The query object mapping method according to claim 9, wherein the field mapping method comprises:
a suffix mapping method, configured to map a field whose name contains a specific suffix in the query object into a corresponding query condition.

11. A computer program product, comprising a computer program, wherein the computer program, when executed by a processor, implements steps of the query object mapping method according to claim 1.

12. The computer program product according to claim 11, wherein the obtaining a query condition corresponding to each assigned field in an instance of a query object by applying an adapted field mapping method comprises:
acquiring an assigned value of each field in the instance of the query object by applying a reflection technology; and
adapting and applying the field mapping method to the assigned field to obtain the corresponding query condition.

13. The computer program product according to claim 11, wherein the obtaining a query condition corresponding to each assigned field in an instance of a query object by applying an adapted field mapping method comprises:
adapting the field mapping methods to all fields of the query object to obtain a field mapping adaptation table corresponding to the query object;
acquiring an assigned value of each field in the instance of the query object by applying a reflection technology; and
adapting and applying the field mapping method to the assigned field according to the field mapping adaptation table to obtain the corresponding query condition.

14. The computer program product according to claim 11, wherein the obtaining a query condition corresponding to each assigned field in an instance of a query object by applying an adapted field mapping method comprises:
calling and executing a query object mapping code by using the instance of the query object to obtain the query condition corresponding to each assigned field in the instance of the query object; wherein the query object mapping code is generated according to all fields of the query object and the corresponding query conditions obtained by adapting and applying the field mapping methods.

15. The computer program product according to claim 11, wherein the field mapping method comprises:
a suffix mapping method, configured to map a field whose name contains a specific suffix in the query object into a corresponding query condition.

16. The computer program product according to claim 12, wherein the field mapping method comprises:
a suffix mapping method, configured to map a field whose name contains a specific suffix in the query object into a corresponding query condition.

17. The computer program product according to claim 13, wherein the field mapping method comprises:
a suffix mapping method, configured to map a field whose name contains a specific suffix in the query object into a corresponding query condition.

18. The computer program product according to claim 14, wherein the field mapping method comprises:
a suffix mapping method, configured to map a field whose name contains a specific suffix in the query object into a corresponding query condition.

19. A computer program product, comprising a computer program, wherein the computer program, when executed by a processor, implements steps of the query object mapping method according to claim 9.

20. The computer program product according to claim 19, wherein the field mapping method comprises:
a suffix mapping method, configured to map a field whose name contains a specific suffix in the query object into a corresponding query condition.
